(19) United States
(12) Patent Application Publication
(10) Pub. No.: US 2021/0029423 A1
(43) Pub. Date: Jan. 28, 2021

(54) OPTICAL PACKET SWITCHING AND PROCESSING FOR DETERMINISTIC NETWORKING

(71) Applicant: Nokia Solutions and Networks Oy, Espoo (FI)

(72) Inventors: Ejder BASTUG, Paris (FR); Bogdan USCUMLIC, Bures-sur-Yvette (FR); Sameerkumar SHARMA, Holmdel, NJ (US)

(21) Appl. No.: 16/522,313

(22) Filed: Jul. 25, 2019

(51) Int. Cl. H04Q 11/00

(52) U.S. Cl. CPC H04Q 11/0066; H04Q 11/0005; H04Q 2011/002; H04Q 2011/0088; H04Q 2011/0094

(57) ABSTRACT

A first optical node is configured for deployment in an optical network including second optical nodes having a ring topology. The first optical node includes an optical encoder and a decoder. The optical encoder is configured to form a third optical signal for transmission into the optical network by combining a first optical signal generated by the first optical node with a second optical signal received by the first optical node from the second optical nodes. The decoder is configured to extract information from fourth optical signals received from the second optical nodes. In some cases, the first optical node includes a receive buffer configured to store information representative of the fourth optical signals received from the second optical nodes and a transmit buffer configured to store information used to generate the first optical signal.

### BACKGROUND

Optical switches typically are implemented for routing optical signals through an optical network such as the optical fiber infrastructure deployed in data centers, fronthaul networks, cross-haul networks, metro networks, and the like. For example, optical nodes deployed in a ring topology can provide connectivity with high throughput and bounded latency/jitter by performing much (if not all) of the processing and packet switching in the optical domain. Conventional optical transmission and switching is performed in an optical network using wavelength division multiplexing (WDM). Optical packet switching (OPS) is a switching technology that allows an optical switch in a node to route an input optical WDM packet to an optical output port without converting the entire WDM packet into an electrical/digital signal. An OPS node receives a WDM packet and converts an optical header in the WDM packet into a digital signal using optical-to-electrical-to-optical (OEO) conversion. Information in the header is used to configure the optical switch to route an optical payload of the WDM packet and schedule the optical payload of the WDM packet for transmission. The optical node does not convert the optical payload into an electrical/digital signal and, consequently, optical switching for the optical payload increases capacity and energy efficiency of the optical network relative to switches or routers in networks that convert the entire packet into an electrical/digital signal.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an optical packet switching (OPS) network including multiple nodes having ring topologies according to some embodiments.

FIG. 2 is a block diagram of a conventional ring network including nodes arranged in a ring topology.

FIG. 3 is a block diagram of a conventional OPS node that routes transient traffic in two directions such as clockwise and counterclockwise in a ring network of OPS nodes.

FIG. 4 is a block diagram illustrating operation of a conventional OPS node when incoming links to the OPS node are idle and active.

FIG. 5 is a block diagram of an OPS node that performs optical packet processing and switching for a deterministic network according to some embodiments.

FIG. 6 is a block diagram illustrating operation of an OPS node in different time intervals of a round of a ring network including the OPS node according to some embodiments.

FIG. 7 is a flow diagram of a method of selectively encoding optical packets at an OPS node depending on the time interval of a round according to some embodiments.

FIG. 8 illustrates evolution of average throughput and reliability with respect to the link failure probability in a ring network of four nodes with a broadcast demand profile according to some embodiments.

FIG. 9 illustrates evolution of average throughput and reliability with respect to the link failure probability in a ring network of four nodes with a peer-to-peer demand profile according to some embodiments.

FIG. 10 illustrates evolution of average throughput and reliability with respect to the link failure probability in a ring network of four nodes with a multicast demand profile according to some embodiments.

FIG. 11 illustrates evolution of average throughput and reliability with respect to the link failure probability in a ring network of four nodes with a server/client demand profile according to some embodiments.

### DETAILED DESCRIPTION

Optical networks, particularly optical networks implemented according to Fifth Generation (5G) standards, are required to satisfy stringent latency requirements. One approach to satisfying the latency requirements is “deterministic networking.” Packet arrival times and latencies are known accurately in advance in a deterministic network. One deterministic networking technique is time-aware shaping of packets that are scheduled for transmission by a transmission scheduler that selects packets for scheduling from a set of ingress queues. A gate control list (GCL) identifies the ingress queues that are considered by the transmission scheduler in a sequence of time intervals that are referred to as traffic windows. The pattern of ingress queues that are considered in each traffic window is referred to as a gate control entity (GCE). The GCL is therefore a list of GCEs for the sequence of traffic windows. Different flows are mapped to different ingress queues. The GCL defines time-aware traffic windows in which only packets from ingress queues corresponding to specified flows are allowed to be transmitted. For example, the GCL can be configured so that only a first queue associated with a first flow is considered by the scheduler in a time window that corresponds to the time that a first frame in the first flow is expected to arrive in the first queue. All other queues are closed by the GCL in that time window. The scheduler then schedules the only available frame—the first frame in the first queue—for transmission, thereby avoiding collisions and the resulting transmission delays.

As discussed above, conventional optical switches are configured to route and schedule optical packets based on information included in an optical header of the optical packet. Implementing deterministic networking in a conventional optical network therefore requires OEO conversion of at least the header of the optical packet. Processing of the optical packet, including the OEO conversion needed to extract routing/scheduling information from the optical header of the optical packet, increases the latency of the packet and increases uncertainty in the processing time. The increased latency can render transmission of the optical packet non-deterministic, which is contrary to the goal of reducing network latency and nullifying jitter using deterministic networking. These problems are exacerbated when the optical network is heavily loaded because the scheduling policies for allocating the limited resources of the optical network result in higher latency and lower throughput. Furthermore, failure of one or more of the optical nodes results in the loss of optical packets and the resulting recovery time significantly degrades the average throughput of the optical network.

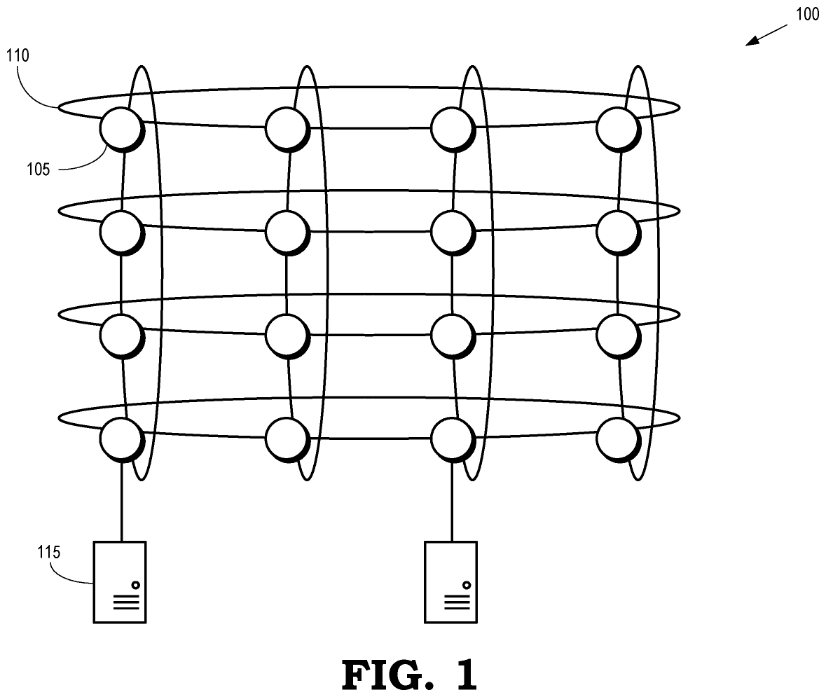

FIGS. 1-11 disclose embodiments of an optical node configured for deployment in an optical network having a ring topology that provides lower latency and increased resilience to link failures using an optical encoder that combines a first optical signal generated by the optical node with a second optical signal received by the optical node from a neighboring optical node prior to transmitting the combined (third) optical signal. Some embodiments of the optical node generate the first optical signal based on information stored in a transmit buffer. The optical node also stores information represented by the second optical signal in a receive buffer. The optical encoder combines the first and second optical signals using an optical arithmetic unit (OAU) that performs a binary exclusive-OR (XOR) on the information represented by the first and second optical signals to generate the encoded third optical signal. The process of combining optical signals generated and received by the optical node is iterated for a plurality of time intervals in a round. Depending on the transmission mode of the nodes, the optical node extracts information transmitted by one or more other optical nodes in the optical network from information stored in the receive buffer either during the round or in response to reaching the end of the round. Each entry in the receive buffer corresponds to a linear combination of optical signals generated by the optical nodes in the optical network. The information represented by the optical signals is extracted using matrix operations determined by the ring topology. Some embodiments of the optical node use subsets of the linear combinations stored in the receive buffer to recover from link failures.

Some embodiments of the optical node partition optical packets into first and second portions that are encoded prior to transmitting the first and second portions to other optical nodes in the optical network. Different encodings are applied in different time intervals. Each round includes an initial time interval and subsequent time intervals that are partitioned into even time intervals (e.g., the second, fourth, etc.) and odd time intervals (e.g., the third, fifth, etc.). The optical node encodes the first and second portions, e.g., using the XOR implemented by the optical encoder, and transmits the encoded signal into the optical network in a first direction (such as clockwise) and a second direction (such as counterclockwise). Subsequently, in even time intervals, the first portion is encoded with optical signals received from the second direction and the encoded signal is transmitted in the first direction. The second portion is encoded with optical signals received from the first direction and the encoded signal is transmitted in the second direction. In odd time intervals, the second portion is encoded with optical signals received from the second direction and the encoded signal is transmitted in the first direction. The first portion is encoded with optical signals received from the first direction and the encoded signal is transmitted in the second direction. If no link failures have occurred, optical signal transmitted by the optical node is recovered by the end of the round by all other optical nodes in the optical network, and the optical node can recover optical signals transmitted by the other optical nodes during the round. In the event of one or more link failures, buffered values of linear combinations of the received signals are used to recover some or all of the lost packets. Thus, decreased latency and increased resilience to link failures are purchased at the cost of additional computational decoding complexity in the optical node.

FIG. 1 is a block diagram of an optical packet switching (OPS) network 100 including multiple nodes having ring topologies according to some embodiments. The OPS network 100 consists of multiple ring structures forming a torus network is used to considered in data centers. In other embodiments, a ring topology is implemented in fronthaul networks, cross-haul networks, metro networks, or other types of networks. Some embodiments of the OPS network 100 implement time-division multiplexing (TDM) and wavelength-division multiplexing (WDM) to provide increased capacity and energy efficient networking. The OPS network 100 includes OPS nodes 105 (only one indicated by a reference numeral in the interest of clarity) that are connected in a ring topology using rings 110 (only one indicated by a reference numeral in the interest of clarity), e.g., rings that are formed of optical fibers that support TDM/WDM communications in multiple frequency bands. One or more servers 115 (only one indicated by a reference numeral in the interest of clarity) are connected to the OPS network 100 to transmit information into the OPS network 100 and receive information from the OPS network 100.

The OPS nodes 105 are arranged in the ring topology to provide connectivity with high throughput and bounded latency/jitter by performing as much processing and packet switching in the optical domain as possible. Resources in the OPS nodes 105 such as the number of WDM wavelengths available to convey data or control signaling are limited. Centralized scheduling and corresponding signaling is therefore used for communication between the OPS nodes 105 to minimize the amount of time spent waiting, the number of collisions between packet flows, and the number of packet flows that are dropped. Scheduling in this manner generally provides a better quality of service. If the observed performance does not satisfy targets for the scheduling policy, an operator of the OPS network 100 can upgrade the OPS nodes 105 by adding more transmission or reception wavelengths for offloading a routing of traffic. However, this approach introduces additional operation and installation costs.

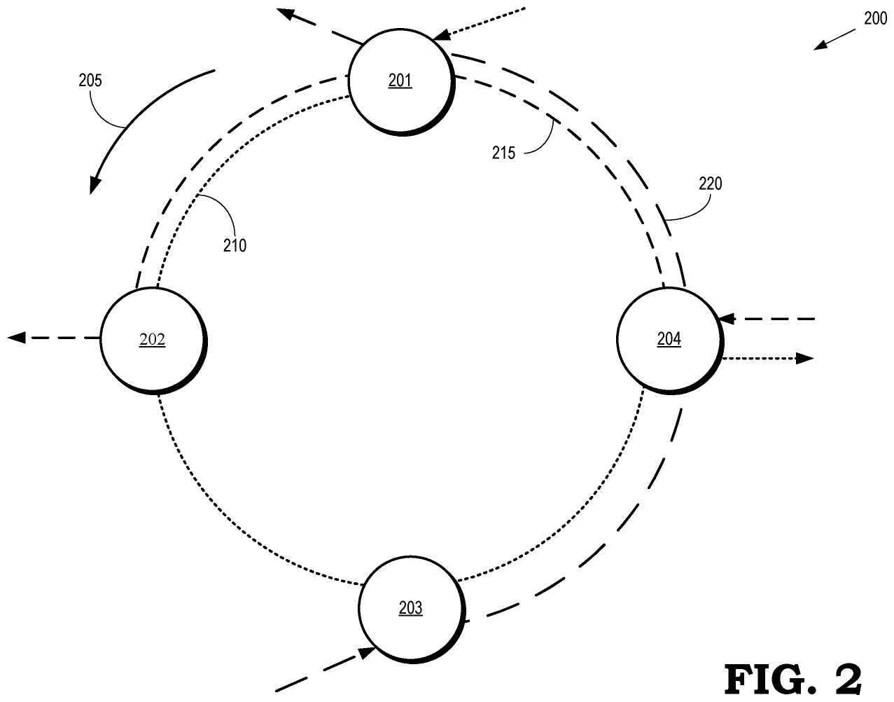

FIG. 2 is a block diagram of a conventional ring network 200 including nodes 201, 202, 203, 204 arranged in a ring topology. Optical signals travel around the conventional ring network 200 in a counterclockwise direction as indicated by the arrow 205. However, the conventional ring network 200 is implemented as a bidirectional ring network so that optical signals concurrently traverse the conventional ring network 200 in both the clockwise direction and the counterclockwise direction. Signals traveling in the clockwise direction are not shown in FIG. 2 in the interest of clarity. Optical signals in a flow move one hop per timeslot and the timeslots are grouped into “rounds.” The number of timeslots in a round is determined by the number of nodes 201-204 in the conventional ring network 200, which is referred to herein as the “size” of the conventional ring network 200. For example, the number of timeslots in a round can be set to N-1 (e.g., three) if there are N (e.g., four) nodes in the conventional ring network 200. Thus, an optical signal can move from the node 201 to the node 204 in a round.

The conventional ring network 200 is configured to support non-blocking flows or, alternatively, no waiting delay or packet drop for the flows. The conventional ring network 200 is supporting three flows 210, 215, 220. The flow 210 (indicated by the dotted line) enters the conventional ring network 200 at the node 201, traverses the nodes 202, 203, and exits the conventional ring network 200 at the node 204. The flow 215 (indicated by the medium dashed line) enters the conventional ring network 200 at the node 204, traverses the node 201 and exits the conventional ring network 200 at the node 202. The flow 220 (indicated by the long dashed line) enters the conventional ring network 200 at the node 203, traverses the node 204, and exits the conventional ring network 200 at node 201. Different types of resource allocation schemes can be applied to support the flows and the different schemes have different advantages and drawbacks.

In one case, the nodes 201-204 do not support optical packet switching and instead the nodes 201-204 use optical circuit switching. The nodes 201-204 therefore support at least three wavelengths to convey the three overlapping flows 210, 215, 220 in different timeslots. Allocating at least three wavelengths allows each of the flows 210, 215, 220 to transmit without any overlapping. For example, a first wavelength can carry the flow 210 and a second wavelength can carry the flow 220. The first wavelength is unavailable between the node 201 and the node 202, while the second wavelength is unavailable between the node 201 and the node 204. Consequently, a third wavelength is activated to support the flow 215, which traverses the conventional ring network 200 between the node 201 and the node 204. This approach supports the flows 210, 215, 220 without blocking, waiting delays, or packet drops. However, the resources of the conventional ring network 200 are highly underutilized.

In another case, the nodes 201-204 implemented as OPS nodes perform wavelength conversion or packet switching. The flows 210, 215, 220 are supported using only two wavelengths because each of the OPS nodes 201-204 can route optical packets in the optical flows 210, 215, 220 to different wavelengths in different timeslots. For example, the node 204 can route the packets in the flow 210 to the first wavelength for the hop to the node 201 and the node 201 can route the packet to the flow 210 to the second wavelength for the hop to the node 202. This approach reduces the number of wavelengths that are needed to support the flows 210, 215, 220 without blocking, waiting delays, or packet drops. However, wavelength conversion or packet switching requires an additional control channel that is transmitted on another wavelength at additional cost. Furthermore, the packets in the flows 210, 215, 220 need to be buffered to provide time to schedule the packets on the appropriate wavelengths. An advanced sub-optimal scheduling policy with buffering might require optical-electronic-optical conversion, which typically increases latency, decreases throughput, and generally degrades performance. These drawbacks are exacerbated if the number of supported wavelengths is lower than an optimal number, e.g., two wavelengths in the illustrated embodiment.

The scheduling and resource allocation problem shown in FIG. 2 is an example of a graph coloring problem on a conflict graph of flows that is used to find a minimum number of wavelengths or resources to support flows in the conventional ring network 200. The minimum number of colors indicates the required number of wavelengths. However, the graph coloring problem is known to be computationally intractable and so the number of wavelengths that are actually deployed in the ring network is likely to be non-optimal. Performance degradation can therefore occur, potentially resulting in unbounded latency and lower throughput, if the number of wavelengths that are actually deployed in the OPS nodes 201-204 is limited and non-efficiently used.

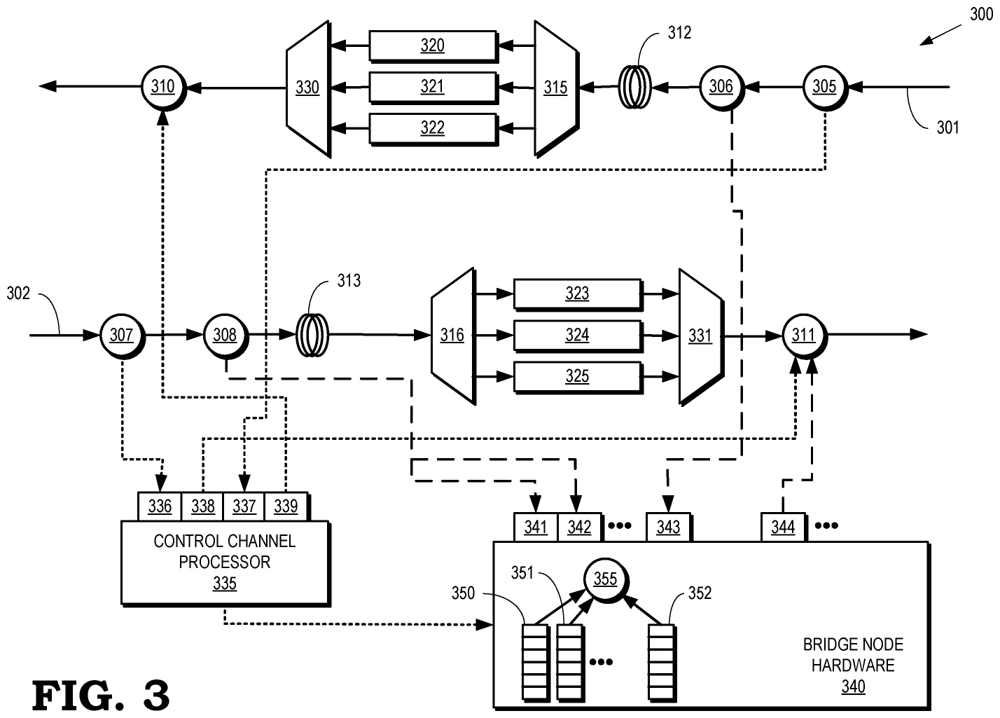

FIG. 3 is a block diagram of a conventional OPS node 300 that routes transient traffic in two directions such as clockwise and counterclockwise in a ring network of OPS nodes. The OPS node 300 receives a first WDM optical signal 301 from another optical node in the ring network in a first direction relative to the OPS node 300. The first WDM optical signal 301 includes control signaling and data signaling on multiple wavelength channels. The OPS node 300 also receives a second WDM optical signal 302 from another optical node in the ring network in a second direction relative to the OPS node 300. The second WDM optical signal 302 includes control signaling and data signaling on multiple wavelength channels.

The conventional OPS node 300 includes splitters 305, 306, 307, 308 that selectively direct different wavelengths along different routes and combiners 310, 311 that combine optical signals on different wavelengths into a single WDM signal. Fiber delay lines 312, 313 delay optical signals to provide latency needed for control channel processing. The de-multiplexers 315, 316 distribute the different wavelengths to wavelength-dependent packet blockers 320, 321, 322, 323, 324, 325 that can be configured to block or transmit packets on corresponding wavelengths. The multiplexers 330, 331 re-combine signals on the different wavelengths into a single WDM signal. A control channel processor 335 includes receivers 336, 337 that receive control signaling packets and transmitters 338, 339 that transmit control signaling packets generated by the control channel processor 335.

Bridge node hardware 340 includes receivers 341, 342, 343 that receive data packets and one or more transmitters 344 that transmit data packets. The bridge node hardware 340 also includes a set of queues 350, 351, 352 that hold information used to generate optical packets for transmission from the OPS node 300. A scheduler 355 schedules the optical packets in the queues 350-352 based on weights or priorities associated with the queues 350-352. The scheduler 355 does not provide deterministic jitter or latency guarantees.

In operation, the splitter 305 redirects a copy of the control signaling packet from the first WDM optical signal 301 to the receiver 337, as indicated by the dotted line, and the splitter 306 redirects a copy of the data packet from the first WDM optical signal 301 to the receiver 343, as indicated by the dashed line. The splitter 307 redirects a copy of the control signaling packet from the second WDM optical signal 302 to the receiver 336, as indicated by the dotted line, and the splitter 308 redirects a copy of the data packet from the second WDM optical signal 302 to the receivers 341, 342. The control channel processor 335 processes the control signaling and generates a control signal that is provided to the bridge node hardware 340. The control channel processor 335 also generates control signaling packets that are transmitted from the transmitter 338 to the combiner 311 and from the transmitter 339 to the combiner 310. The transmitter 344 in the bridge node hardware 340 provides optical data packets to the combiner 311. Although not shown in FIG. 3 in the interest of clarity, additional transmitters in the bridge node hardware 340 can provide data packets to the combiner 310.

The control channel, optical packet switching, and scheduling employed in the OPS node 300 support relatively high peak throughput in the ring network. However, the ring network is subject to fluctuations in latency and throughput, as discussed herein.

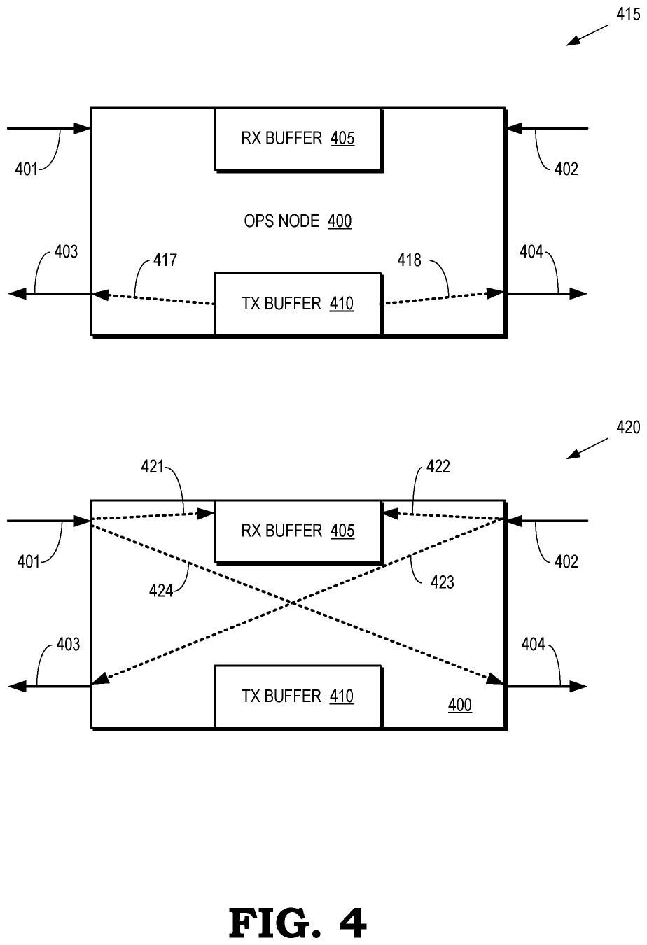

FIG. 4 is a block diagram illustrating operation of a conventional OPS node 400 when incoming links to the OPS node are idle and active. The conventional OPS node 400 is implemented using some embodiments of the conventional OPS node 300 shown in FIG. 3. The conventional OPS node 400 includes incoming links 401, 402 from the two directions of a bidirectional ring network and outgoing links 403, 404 towards the two directions of the bidirectional ring network. The conventional OPS node 400 also includes a receive buffer 405 that stores optical packets received on the incoming links 401, 402 and a transmit buffer 410 that stores optical packets prior to transmission of the optical packets on the outgoing links 403, 404.

The incoming links 401, 402 are idle in the time interval 415. The OPS node 400 uses the idle time interval 415 to transmit optical packets from the transmit buffer 410, as indicated by the arrows 417, 418. The incoming links 401, 402 are active in the time interval 420. Optical packets received on the incoming links 401, 402 are stored in the receive buffer 405, as indicated by the arrows 421, 422. Depending on the traffic demand, copies of the optical packets received on the incoming links 401, 402 are also provided transparently to the outgoing links 403, 404 corresponding to the direction of the incoming links 401, 402. For example, optical packets received on the incoming link 402 are provided to the outgoing link 403, as indicated by the arrow 423, and optical packets received on the incoming link 401 are provided to the outgoing link 404, as indicated by the arrow 424.

Selective routing of the optical packets through the conventional OPS node 400 can be represented as pseudocode using the following notation:
Link 401 for the left side of incoming packet flow is denoted as Lₙₗ. The received transient packet at a given timeslot is denoted as P_{L}_{ₙₗ}.

Link 402 for the right side of incoming packet flow is denoted as Lₙᵣ. The received transient packet at a given timeslot is denoted as P_{L}_{ₙᵣ}.

Link 403 for the left side of outgoing packet flow is denoted as L′ₙᵣ. The transmittable packet of OPS node (if available in the electronic transmit buffer) at a given timeslot is denoted by pₙ₁.

Link 404 for the right side of outgoing flow is denoted as L′ₙᵣ. The transmittable packet of OPS node (if available in the electronic transmit buffer) at a given timeslot is denoted by pₙ₂.

The following pseudocode also assumes that 1) a standard time synchronization mechanism over control channel is available and 2) each “round” represents a fixed number of timeslots pre-agreed by all network nodes.

input: Lₙₗ, Lₙᵣ
outputs: L′ₙₗ, L′ₙᵣ

| | |
|---|---|
| round = PerformTimeSynchronization( ) | // Perform time |

synch. to start a new round

| | |
|---|---|
| while round.next( ) | // Work over all |

transmission rounds

| | |
|---|---|
| while round.timeSlot.next( ); | // Work over all |

timeslots of a given round

// Transmission and Receive
if state(Lₙₗ) is IDLE

transmit to right: {packet Pₙ₂ from electronic buffer} =>

{right outgoing link L′ₙᵣ}

else

forward to right: {P_{L}_{ₙₗ}} => {right outgoing link L′ₙᵣ}
receive from left: {P_{L}_{ₙₗ}} => {electronic receive buffer}

end
if state(Lₙᵣ) is IDLE

transmit to left: {packet Pₙ₁ from electronic buffer} =>

{left outgoing link L′ₙₜ}

else

forward to left: {P_{L}_{ₙᵣ}} => {left outgoing link L′ₙₗ}
receive from right: {P_{L}_{ₙᵣ}} => {electronic receive buffer}

end

end

decode: {electronically decode intended received packets from

receive buffer}
end

As discussed above, conventional OPS nodes in ring networks, such as the node 300 shown in FIG. 3 and the node 400 shown in FIG. 4, might not perform optimally and efficiently in various network conditions. In some cases, large numbers of flows and large numbers of optical packets result in higher latency and lower throughput because of inefficient usage of limited resources (e.g., wavelengths) and the scheduling policies implemented in schedulers such as the scheduler 355 shown in FIG. 3. Dedicating additional resources such as more wavelengths or timeslots to support higher traffic volume can improve performance but at the cost of underutilizing the resources when traffic is light. These drawbacks are addressed by modifying conventional OPS nodes to encode optical packets by combining optical packets received by the OPS node with optical packets generated for transmission by the OPS node, e.g., using an exclusive-or (XOR) operation. The encoded packets are transmitted onto the ring network and other OPS nodes can decode the received encoded packets using matrix operations that are determined by the ring topology of the ring network. Encoding packets at the OPS node produces lower latency and increased resilience to link failures at the cost of increased computational complexity at the OPS node.

Some embodiments of the modified OPS node include an optical encoder that is configured to perform algebraic summation operations in the optical domain, e.g., utilizing optical XOR elements. The optical encoder combines transient traffic coming from both directions and forwards the encoded optical packets to the outputs during the next timeslot. Incorporating the optical encoder removes the need for routing or time/spatial division multiplexing by scheduling the optical packets across multiple timeslots or multiple wavelengths. Some embodiments of the modified OPS nodes also include an electrical decoder that decodes the incoming signal by solving a set of linear equations that are determined based on the ring topology. One benefit of using the optical encoder is that the transient traffic between nodes in the OPS-based ring network does not need to go through an optical-electrical-optical conversion because the OPS nodes perform the encoding in the optical domain, which allows the OPS node to rapidly process the transient traffic in a non-blocking manner, therefore resulting in higher throughputs. A communication protocol for the modified OPS node allows the OPS nodes in the ring network to encode and decode optical packets. The communication protocol guarantees deterministic jitter and delay by coordinating the OPS nodes to improve recovery and decoding of the received optical signals after a fixed number of rounds, which increase the reliability of the network, as well as improving throughput.

In the following description of some embodiments, the structure and operation of OPS nodes are discussed in the context of a bidirectional ring network of N nodes represented by a set [symbol] =1,2,3, . . . N. Nodes transmit packets to other nodes in the ring network, receive their intended packets, or relay packets to neighbor nodes thus allowing transient traffic to reach its destination at one of the other nodes in the ring network. Each node n in the ring network includes bidirectional (transmission/reception or outgoing/incoming) links. The following notation is used to indicate the links and corresponding directions:
Link for the left side of incoming packet flow is denoted as Lₙₗ
Link for the right side of incoming packet flow is denoted as Lₙᵣ
Link for the left side of outgoing packet flow is denoted as L′ₙₗ
Link for the right side of outgoing flow is denoted as L′ₙᵣ

The ring network has optical packet switching capabilities that can operate in multiple wavelengths in the optical domain without need of optical-electrical-optical conversion. However, in the interest of clarity, the following discussion focuses on single wavelength communication without loss of generality.

Nodes include a transmit buffer and a receive buffer in the electronic domain. Packets in the transmit buffer are forwarded to the optical domain for transmission. In some cases, packets are converted from the optical domain to the electronic domain via the receive buffer. The packets in the electronic receive buffer of a node are sent to upper layers of the node for further processing.

All network nodes are synchronized in time, where each transmission (or reception) is done in a time block/round that can take up to T timeslots. In its circuit, a node is allowed to insert a packet from the electronic domain to the optical domain in any timeslot, as long as the optical slot is empty or insertion of the packet does not cause a transient packet to be dropped. As used herein, the term “transient packet” refers to a packet that is received at a node but is not destined for the node. The receiving node is only responsible for forwarding the transient packet around the ring network. Nodes also receive optical packets in any timeslot by converting the optical packet to an electronic packet and storing the electronic packet in the receive buffer for further processing. The node decodes electronic packets that are destined for the node.

The worst-case demand scenario for a ring network composed of OPS nodes is a broadcast demand profile in which all nodes transmit and receive from all other nodes. However, the ring network can operate in other demand profiles such as peer-to-peer, server-client, multicast, and the like. Simulation results for the broadcast, peer-to-peer, server-client, and multicast demand profiles are provided below. The broadcast demand profile is discussed in detail below.

In broadcast demand profile, each round consists of max. T timeslots. Initially, each node n intends to broadcast its packet Pₙ to all other nodes in the ring network, which is denoted as [symbol] ={m ∈ [symbol] |m≠n}. In this situation, the ring network is fully loaded during T timeslots because all nodes have to transmit/receive/forward packets until all packet demands are satisfied/delivered. Each node inserts a new packet at the first timeslot of a communication round and new packet insertions during the other slots of the round are not possible because the links are fully occupied. Inserting new packets in this situation would cause packet drops. A new packet could be inserted by performing optical-electrical-optical conversion with buffering, which would cause unpredictable delays and jitter due to sub-optimal scheduling mechanisms. In the illustrated embodiments, the broadcast demand profile forces the ring network to be fully loaded in a single communication round. Packet insertion in low-loaded demand scenarios (e.g., multicast) is evaluated below.

For a given node n at given round, the packet Pₙ is divided into two subpackets such as Pₙ₁ and Pₙ₂. Conventional OPS nodes such as the OPS node 300 shown in FIG. 3 transmit the subpacket Pₙ₁ through left outgoing link L′ₙₗ and the packet Pₙ₂ is sent through right outgoing link L′ₙᵣ during available timeslots. At any given timeslot, a packet coming from left and right links are denoted by P_{L}_{ₙₗ} and the P_{L}_{ₙᵣ}, respectively. In a network with fully loaded broadcast demand profile and zero link failure, the timeslots of a round are set to T=N-1, such that all demands can be satisfied. In case of link failures or low-loaded demand scenarios, the number of timeslots can be higher or lower than N-1 respectively, since packets might be re-transmitted or might not be required to traverse all the network respectively.

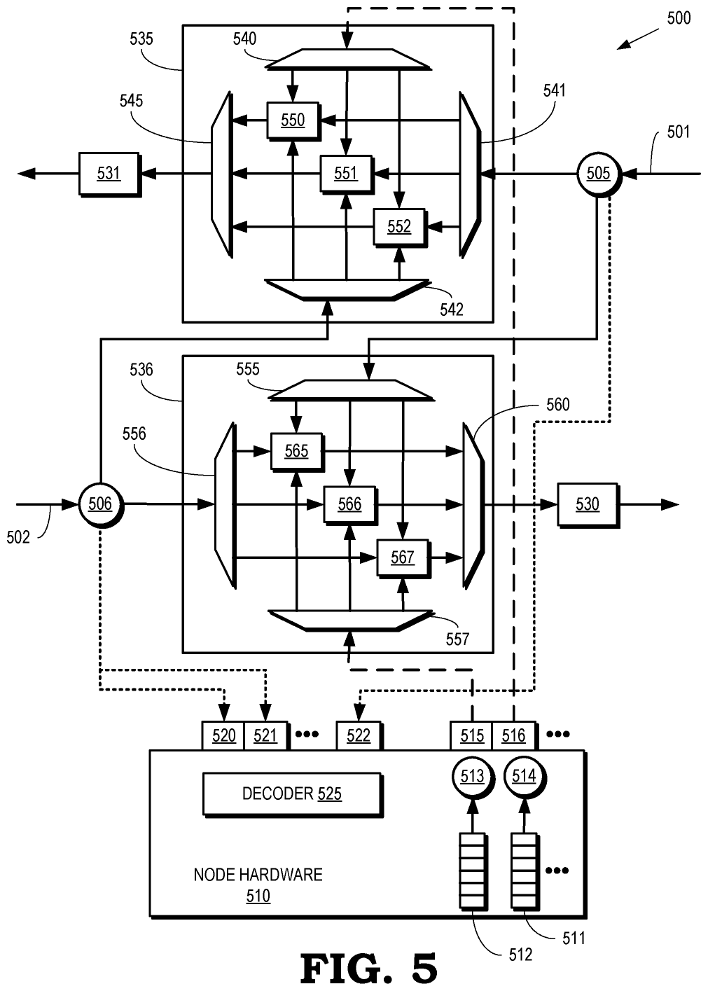

The outgoing links from nodes in the network are subject to failures. In order to estimate the effect of network link failures, a failure event of an outgoing link is drawn from an i.i.d. Bernoulli random variable with failure probability p_{fail} and success probability 1−p_{fail} during each timeslot. In the event of failure, an outgoing link provides no packet to its neighbours in their current timeslot. In some cases, the node re-transmits the packet in the next timeslots. The performance of a state-of-the-art baseline communication scheme (e.g., using a conventional OPS node) is compared to the performance of a modified OPS node such as the OPS node 500 discussed below with regard to FIG. 5, taking also into account zero/nonzero link failures and various practical demand profiles.

In a scenario where p_{fail}=0 and T is at least N-1, the performance of the modified OPS node is always better, at the cost of introducing additional encoding/decoding computational complexity. In a real-world scenario, queueing delays in the conventional method, optical-electrical-optical conversion delays, and link failures reduce effective throughput and cause more delay and jitter in the ring network. In contrast, the modified OPS node increases performance of the ring network using packet encoding to create “memory” of the packet flows and by fully utilizing the links in both directions, thanks to its special encoding and decoding mechanism.

FIG. 5 is a block diagram of an OPS node 500 that performs optical packet processing and switching for a deterministic network according to some embodiments. The OPS node 500 is used to implement some embodiments of the nodes 110 shown in FIG. 1 and the nodes 201-204 shown in FIG. 2. The OPS node 500 is deployed in a ring network having a ring topology and operates in a bidirectional mode that receives and transmits optical signals in a first direction (e.g., clockwise) and a second direction (e.g. counterclockwise). In the illustrated embodiment, the OPS node 500 receives a first WDM optical signal 501 from another optical node in the ring network in a first direction relative to the OPS node 500. The first WDM optical signal 501 includes data signaling on multiple wavelength channels. The OPS node 500 also receives a second WDM optical signal 502 from another optical node in the ring network in a second direction relative to the OPS node 500. The second WDM optical signal 502 includes data signaling on multiple wavelength channels. The control channel used for label processing and scheduling in a conventional OPS node (such as the conventional OPS node 300 shown in FIG. 3) is not needed in the OPS node 500.

The OPS node 500 includes splitters 505, 506 that selectively direct different wavelengths along different routes. Node hardware 510 generates information included in optical packets that are transmitted by the OPS node 500. The node hardware 510 includes buffers 511, 512 and corresponding schedulers 513, 514 that provide optical packets from the buffers 511, 512 to the transmitters 515, 516. In the illustrated embodiment, the schedulers 513, 514 use first-in-first-out (FIFO) scheduling to schedule optical packets for transmission by the corresponding transmitters 515, 516. Thus, scheduling is provided with no jitter (or jitter below a predetermined tolerance) and a fixed latency. The node hardware 510 includes receivers 520, 521, 522 to receive encoded optical signals from neighboring OPS nodes and a decoder 525 to decode the encoded optical signals using matrix operations determined by the ring topology, as discussed herein. Optical amplifiers 530, 531 amplify optical signals prior to transmission from the OPS node 500 onto the ring network.

The OPS node 500 includes optical encoders 535, 536 that encode the optical signals received from the splitters 505, 506 and signals generated by the node hardware 510. The optical encoder 535 includes demultiplexers 540, 541, 542, multiplexer 545, and optical arithmetic units (OAUs) 550, 551, 552. The optical encoder 536 includes demultiplexers 555, 556, 557, multiplexer 560, and optical arithmetic units (OAUs) 565, 566, 567. The demultiplexers 540-542, 555-557 split WDM optical signals into their component wavelength channels and the OAUs 550-552, 565-567 encode the optical signals by combining the optical signals on the different channels. Some embodiments of the OAUs 550-552, 565-567 encode the optical signals using XOR operations. The multiplexers 545, 560 combine the optical signals on the different channels into a WDM optical signal for transmission to a neighboring OPS node in the ring network. Although three wavelengths (and corresponding numbers of demultiplexers and OAUs) are shown in FIG. 5, some embodiments of the OPS node 500 support a larger number of wavelengths such as 40 wavelengths, 80 wavelengths, or more depending on the spectral characteristics and definitions of the wavelength channels.

Some embodiments of the OPS node 500 use the following communication protocol to combine or encode incoming optical packets with optical packets generated by the OPS node 500. For example, locally generated optical packets are encoded with incoming optical packets using bitwise XOR operator (denoted as ⊕) in an algebraic way. The OPS node 500 and neighbor OPS nodes store received encoded packets in a receive buffer and decode the packets during or at the end of each communication round, depending on the communication mode. Thus, each OPS node combines the packets incoming from both directions in different timeslots, injects its own packet if needed, and transmits the encoded packets in both directions. The proposed scheme always utilizes its link and creates combinations of packet in the optical domain, thus creating a network with memory which is less prone to link errors, at the cost of computational decoding complexity.

The following pseudocode represents one embodiment of the communication protocol:

inputs: Lₙₗ, Lₙᵣ
outputs: L′ₙₗ, L′ₙᵣ

| | |
|---|---|
| round = PerformTimeSynchronization( ) | // Perform time synch. |

to start a new round

| while round.next( ) | | // Work over all rounds |
|---|---|---|
| | while round.timeSlot.next( ); | // Work over all |

timeslots of a given round

// Encode and Record
if round.timeSlot is 1

| | |
|---|---|
| encode both: {Pₙ₁ ⊕ Pₙ₂} | => {left outgoing link L′ₙₗ |

and electronic receive buffer}

=> {right outgoing link L′ₙᵣ

and electronic receive buffer}

record tx: {Pₙ₁ from electronic transmit buffer} =>

{electronic receive buffer}

{Pₙ₂ from electronic transmit buffer} =>

{electronic receive buffer}

else if round.timeSlot is EVEN

encode left: {Pₙ₁ ⊕ P_{L}_{ₙₗ}} => {left outgoing link L′ₙₗ and

electronic receive buffer}

encode right: {Pₙ₂ ⊕ P_{L}_{ₙᵣ}} => {right outgoing link L′ₙᵣ and

electronic receive buffer}

else if round.timeSlot is ODD

encode left: {Pₙ₂ ⊕ P_{L}_{ₙₗ}} => {left outgoing link L′ₙₗ and

electronic receive buffer}

encode right: {P_{n1 ⊕} P_{L}_{ₙᵣ}} => {right outgoing link L′ₙᵣ and

electronic receive buffer}

end
// Receive
receive left: {packet from left incoming link Lₙₗ} =>

{electronic receive buffer}

receive right: {packet from right incoming link Lₙᵣ} =>

{electronic receive buffer}

end
decode: {electronically decode intended packets in receive

buffer}
end

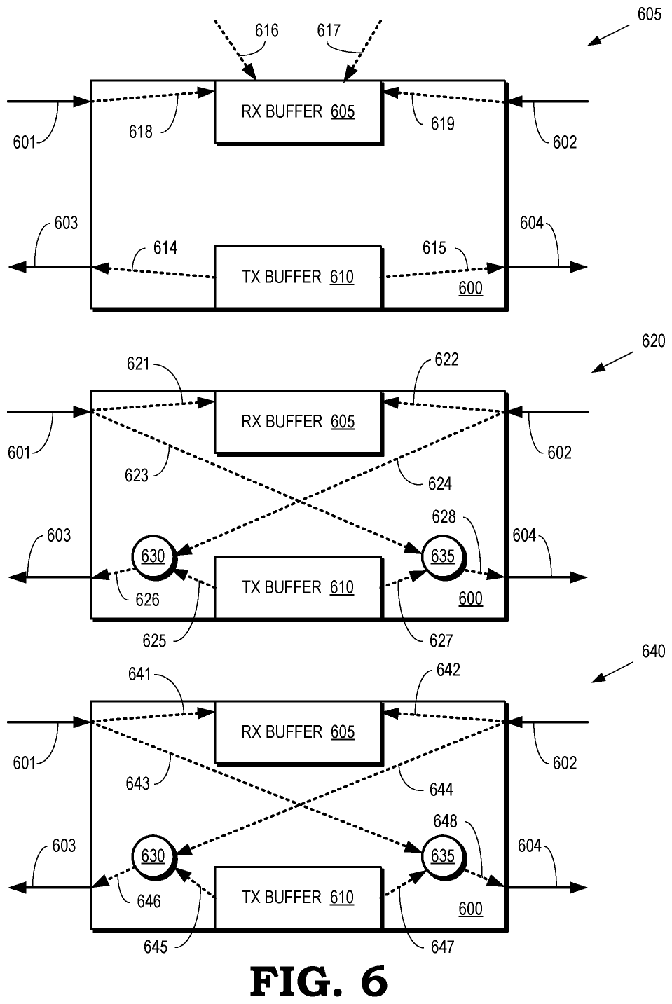

FIG. 6 is a block diagram illustrating operation of an OPS node 600 in different time intervals of a round of a ring network including the OPS node 600 according to some embodiments. The OPS node 600 is implemented using some embodiments of the OPS node 500 shown in FIG. 5. The OPS node 600 includes incoming links 601, 602 from the two directions of a bidirectional ring network and outgoing links 603, 604 towards the two directions of the bidirectional ring network. The OPS node 600 also includes a receive buffer 605 that stores optical packets received on the incoming links 601, 602 and a transmit buffer 610 that stores optical packets prior to transmission of the optical packets on the outgoing links 603, 604. The receive buffer 605 and the transmit buffer 610 are implemented in the electronic domain although some embodiments implement the receive buffer 605 and the transmit buffer 610 in the optical domain.

During an initial time interval 605, a packet generated by the OPS node is extracted from the transmit buffer 610 and partitioned into a first portion and a second portion. The first and second portions are encoded by combining the portions using an XOR operation. The encoded optical packets are then provided to the outgoing links 603, 604, as indicated by the arrows 614, 615. The encoded optical packets are also provided to the receive buffer 605, as indicated by the arrows 616, 617. Optical packets received on the incoming links 601, 602 are stored in the receive buffer 605, as indicated by the arrows 618, 619.

During an even time interval 620, packets received on the incoming links 601, 602 are provided to the receive buffer 605, as indicated by the arrows 621, 622. The packets received on the incoming links 601, 602 are also provided to encoders (or OAUs) 630, 635, as indicated by the arrow 623, 624. Packets generated by the OPS node 600 are transmitted from the transmit buffer 610. The first portion of the packet is transmitted to the encoder 630, as indicated by the arrow 625. The encoder 630 combines the first portion of the packet with the packet received on the incoming link 602 and the combined (encoded) packet is provided to the output link 603, as indicated by the arrow 626. The second portion of the packet is transmitted to the encoder 635, as indicated by the arrow 627. The encoder 635 combines the second portion of the packet with the packet received on the incoming link 601 and the combined (encoded) packet is provided to the output link 604, as indicated by the arrow 628.

During an odd time interval 640, packets received on the incoming links 601, 602 are provided to the receive buffer 605, as indicated by the arrows 641, 642. The packets received on the incoming links 601, 602 are also provided to encoders (or OAUs) 630, 635, as indicated by the arrow 643, 644. Packets generated by the OPS node 600 are transmitted from the transmit buffer 610. The second portion of the packet is transmitted to the encoder 630, as indicated by the arrow 645. The encoder 630 combines the second portion of the packet with the packet received on the incoming link 602 and the combined (encoded) packet is provided to the output link 603, as indicated by the arrow 646. The first portion of the packet is transmitted to the encoder 635, as indicated by the arrow 647. The encoder 635 combines the first portion of the packet with the packet received on the incoming link 601 and the combined (encoded) packet is provided to the output link 604, as indicated by the arrow 648.

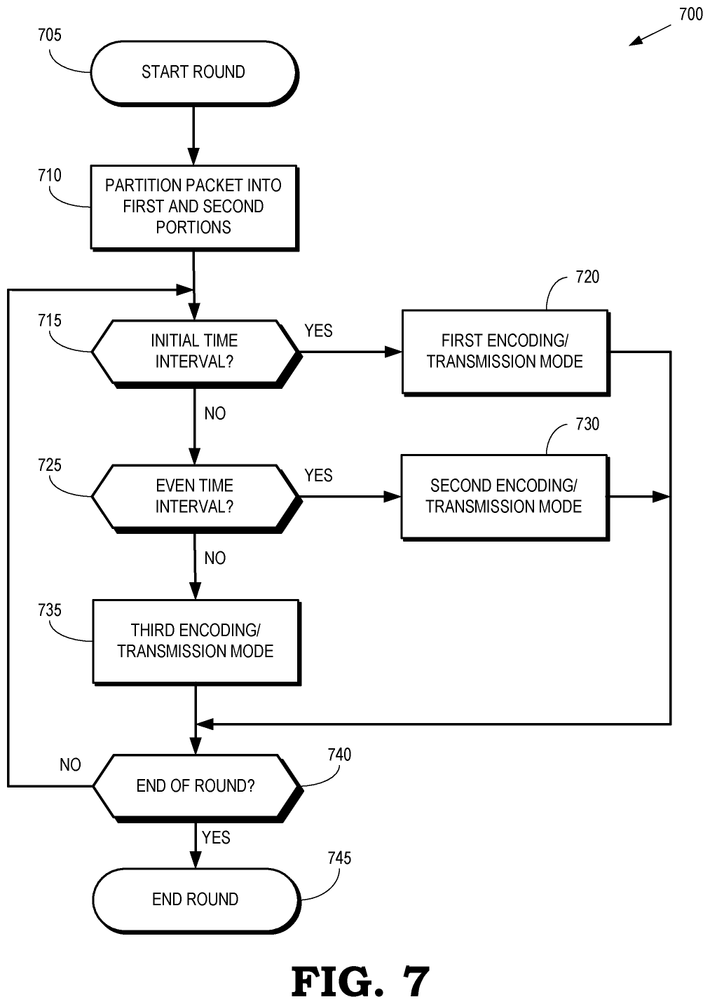

FIG. 7 is a flow diagram of a method 700 of selectively encoding optical packets at an OPS node depending on the time interval of a round according to some embodiments. The method 700 is implemented in some embodiments of the OPS node 500 shown in FIG. 5. The round begins at block 705. In the illustrated embodiment, the OPS node has an optical packet for transmission. At block 710, the OPS node partitions the optical packet into first and second portions that include different subsets of the optical packet.

At decision block 715, the OPS node determines whether the current time interval is the initial time interval of the round. If so, the method flows to block 720 and packets are encoded for transmission according to the first encoding/transmission mode. In some embodiments, the first encoding/transmission mode includes combining the first and second portions of the optical packet using an XOR operation and transmitting copies of the encoded optical packet in a first direction and a second direction into the ring network that includes the OPS node. If the current time interval is not the initial time interval of the round, the method 700 flows to decision block 725.

At decision block 725, the OPS node determines whether the current time interval is an even time interval. If so, the method 700 flows to block 730 and packets are encoded for transmission according to the second encoding/transmission mode. In some embodiments, the second encoding/transmission mode includes combining the first portion with an optical packet that is received from a neighbor OPS node in the second direction. This encoded packet is transmitted into the ring network in the first direction. The second encoding/transmission mode also includes combining the second portion with an optical packet received from the first direction. This encoded packet is transmitted into the ring network in the second direction. If the current time interval is not an even time interval, the method flows to block 735.

At block 735, the current time interval is an odd time interval and packets are encoded for transmission according to the third encoding/transmission mode. In some embodiments, the third encoding/transmission mode includes combining the first portion with an optical packet received from the first direction. This encoded packet is transmitted into the ring network in the first direction. The third encoding/transmission mode also includes combining the second portion with an optical packet received from the second direction. This encoded packet is transmitted into the ring network in the second direction. The method 700 then flows to decision block 740.

At decision block 740, the OPS node determines whether the end of the round has been reached. If so, the method 700 flows to block 745 and the round ends. If the end of the round has not been reached, the method 700 flows to decision block 715 and another iteration is performed for the next time interval of the round.

An example illustrating some embodiments of the communication protocol disclosed herein is discussed below in the context of a ring network having four OPS nodes and operating in a broadcast demand profile with zero link failure, that is p_{fail}=0. A single round consisting of T=3 timeslots is performed. Each node broadcasts a packet to all other nodes in the network:
Node 1 has packet P₁=(00)₂, divided into two subpackets: P₁₁=(0)₂ and P₁₂=(0)₂
Node 2 has packet P₂=(01)₂, divided into two subpackets: P₂₁=(0)₂ and P₂₂=(1)₂
Node 3 has packet P₃=(10)₂, divided into two subpackets: P₃₁=(1)₂ and P₃₂=(0)₂
Node 4 has packet P₄=(11)₂, divided into two subpackets: P₄₁=(1)₂ and P₄₂=(1)₂
   where ( . . . )₂ is base-2 representation of a packet value.

For a node within the end of a single round, with no link failure, and given broadcast demand profile, the amount of required timeslots in a round is N-1 for complete reception of packets, both for the conventional communication protocol and the modified communication protocol disclosed herein because this is the number of time intervals needed for an intended packet to traverse all other nodes (N-1 nodes). In case of link failures, the network would need more time steps to accomplish its delivery tasks. In low-loaded scenarios with no link failures, the network may require less than (N-1) time steps.

As discussed herein, the packets transmitted by a node and the packets received by the node (from both directions of the ring network) in successive time intervals are stored in a receive buffer.

Table 1 illustrates the contents of the receive buffer at the end of the corresponding timeslots. For example, the packet P₄₂ is sent from right outgoing link of Node 4 and travels through Node 1, Node 2, and Node 3 respectively, according to the ring topology. Once the round is over (at the end of 3 timeslots), all nodes have packets sent form other nodes. For example, the receive buffer of Node 1 stores the following subpackets at the end of the round: {P₄₂, P₂₁, P₃₂, P₃₁, P₂₂, P₄₁}. The receiver in Node 1 is therefore able to decode all packets coming from other nodes in broadcast demand scenario using the contents of the receive buffer.

TABLE 1

| | Node 1 | | Node 2 | | Node 3 | | Node 4 | |
|---|---|---|---|---|---|---|---|---|
| Time | Left | Right | Left | Right | Left | Right | Left | Right |
| Slot | L₁ₗ | L₁ᵣ | L₂ₗ | L₂ᵣ | L₃ₗ | L₃ᵣ | L₄ₗ | L₄ᵣ |
| t = 1 | P₄₂ | P₂₁ | P₁₂ | P₃₁ | P₂₂ | P₄₁ | P₃₂ | P₁₁ |
| t = 2 | P₃₂ | P₃₁ | P₄₂ | P₄₁ | P₁₂ | P₁₁ | P₂₂ | P₂₁ |
| t = 3 | P₂₂ | P₄₁ | P₃₂ | P₁₁ | P₄₂ | P₂₁ | P₁₂ | P₃₁ |

Table 2 illustrates the contributions to the receive buffers of the OPS nodes in the ring network at the end of each timeslot in the round. Entries in the receive buffer include the encoded packets generated by the OPS nodes in the ring network according to some embodiments of the techniques disclosed herein.

TABLE 2

| | Node 1 | | Node 2 | | Node 3 | | Node 4 | |
|---|---|---|---|---|---|---|---|---|
| Time | Left | Right | Left | Right | Left | Right | Left | Right |
| Slot | L₁ₗ | L₁ᵣ | L₂ₗ | L₂ᵣ | L₃ₗ | L₃ᵣ | L₄ₗ | L₄ᵣ |
| t = 1 | P₄₁ ⊕ P₄₂ | P₂₁ ⊕ P₂₂ | P₁₁ ⊕ P₁₂ | P₃₁ ⊕ P₃₂ | P₂₁ ⊕ P₂₂ | P₄₁ ⊕ P₄₂ | P₃₁ ⊕ P₃₂ | P₁₁ ⊕ P₁₂ |
| t = 2 | P₃₁ ⊕ P₃₂ | P₃₁ ⊕ P₃₂ | P₄₁ ⊕ P₄₂ | P₄₁ ⊕ P₄₂ | P₁₁ ⊕ P₁₂ | P₁₁ ⊕ P₁₂ | P₂₁ ⊕ P₂₂ | P₂₁ ⊕ P₂₂ |
| | ⊕ P₄₂ | ⊕ P₂₁ | ⊕ P₁₂ | ⊕ P₃₁ | ⊕ P₂₂ | ⊕ P₄₁ | ⊕ P₃₂ | ⊕ P₁₁ |
| t = 3 | P₂₁ ⊕ P₂₂ | P₄₁ ⊕ P₄₂ | P₃₁ | P₁₁ ⊕ P₁₂ | P₄₁ ⊕ P₄₂ | P₂₁ ⊕ P₂₂ | P₁₁ ⊕ P₁₂ | P₃₁ ⊕ P₃₂ |
| | ⊕ P₃₂ | ⊕ P₂₂ | ⊕ P₃₂ | ⊕ P₃₂ | ⊕ P₁₂ | ⊕ P₁₁ | ⊕ P₂₂ | ⊕ P₁₂ |
| | ⊕ P₄₁ | ⊕ P₃₁ | ⊕ P₁₁ ⊕ P₄₂ | ⊕ P₄₁ | ⊕ P₂₁ | ⊕ P₄₂ | ⊕ P₃₁ | ⊕ P₂₁ |

Table 3 illustrates the contents of the receive buffer for node 1 at the end of the round. The entries include incoming encoded packets as well as transmitted and outgoing packets that are recorded at the end of each time interval of the round.

TABLE 3

| Underlying | | |
|---|---|---|
| Packet Combination | Output Value | Comment |
| P₁₁ = | (0)₂ | (recorded initially) |
| P₁₂ = | (0)₂ | (recorded initially) |
| P₄₁ ⊕ P₄₂ = | (0)₂ | (received at t = 1) |
| P₂₁ ⊕ P₂₂ = | (1)₂ | (received at t = 1) |
| P₂₁ ⊕ P₂₂ ⊕ P₁₁ = | (1)₂ | (output recorded at t = 1) |
| P₄₁ ⊕ P₄₂ ⊕ P₁₂ = | (0)₂ | (output recorded at t = 1) |
| P₃₁ ⊕ P₃₂ ⊕ P₄₂ = | (0)₂ | (received at t = 2) |
| P₃₁ ⊕ P₃₂ ⊕ P₂₁ = | (1)₂ | (received at t = 2) |
| P₃₁ ⊕ P₃₂ ⊕ P₁₂ ⊕ P₂₁ = | (1)₂ | (output recorded at t = 2) |
| P₃₁ ⊕ P₃₂ ⊕ P₁₁ ⊕ P₄₂ = | (0)₂ | (output recorded at t = 2) |
| P₂₁ ⊕ P₂₂ ⊕ P₃₂ ⊕ P₄₁ = | (0)₂ | (received at t = 3) |
| P₄₁ ⊕ P₄₂ ⊕ P₂₂ ⊕ P₃₁ = | (0)₂ | (received at t = 3) |

The underlying packet combination and output values (e.g., as shown in Table 3) therefore form a system of linear equations, which can be solved in a deterministic amount of computational time with Gaussian elimination or other methods. The matrices that define the linear combinations of optical packets in the entries of the receive buffer are determined by the ring topology and the encoding scheme and the underlying packet combination is always the same. Computation of packets can be spatially done in modern ASICs/FPGAs, thus eliminating any kind of delay caused by decoding. For example, writing the equations from Table 3 in matrix form produces the following structure:

$$[ \begin{matrix}1 & 0 & 0 & 0 & 0 & 0 & 0 & 0 \\ 0 & 1 & 0 & 0 & 0 & 0 & 0 & 0 \\ 0 & 0 & 0 & 0 & 0 & 0 & 1 & 1 \\ 0 & 0 & 1 & 1 & 0 & 0 & 0 & 0 \\ 1 & 0 & 1 & 1 & 0 & 0 & 0 & 0 \\ 0 & 1 & 0 & 0 & 0 & 0 & 1 & 1 \\ 0 & 0 & 0 & 0 & 1 & 1 & 0 & 1 \\ 0 & 0 & 1 & 0 & 1 & 1 & 0 & 0 \\ 0 & 1 & 1 & 0 & 1 & 1 & 0 & 0 \\ 1 & 0 & 0 & 0 & 1 & 1 & 0 & 1 \\ 0 & 0 & 1 & 1 & 0 & 1 & 1 & 0 \\ 0 & 0 & 0 & 1 & 1 & 0 & 1 & 1\end{matrix} ] * [ \begin{matrix}{P}_{11} \\ {P}_{12} \\ {P}_{21} \\ {P}_{22} \\ {P}_{31} \\ {P}_{32} \\ {P}_{41} \\ {P}_{42}\end{matrix} ] = [ \begin{matrix}0 \\ 0 \\ 0 \\ 1 \\ 1 \\ 0 \\ 0 \\ 1 \\ 1 \\ 0 \\ 0 \\ 0\end{matrix} ]$$

The above structure can be summarized as Cp=y where the matrix C ∈{0,1}^{4T×2N} is the linear combinations of packets, the column vector p represents symbolic packet variables with size of 2N×1 and the vector y is the output values observed at the receive buffer. The coefficient matrix C is full rank due to our transmission scheme, thus all packets are decodable in this setup.

Numerical studies are used to evaluate various performance metrics under several demand profiles and link error probabilities. In particular, a discrete-time event simulation performs transmission/reception of OPS nodes in an optical ring network, while mimicking link failure events via probabilistic Monte-Carlo trials. Each point in

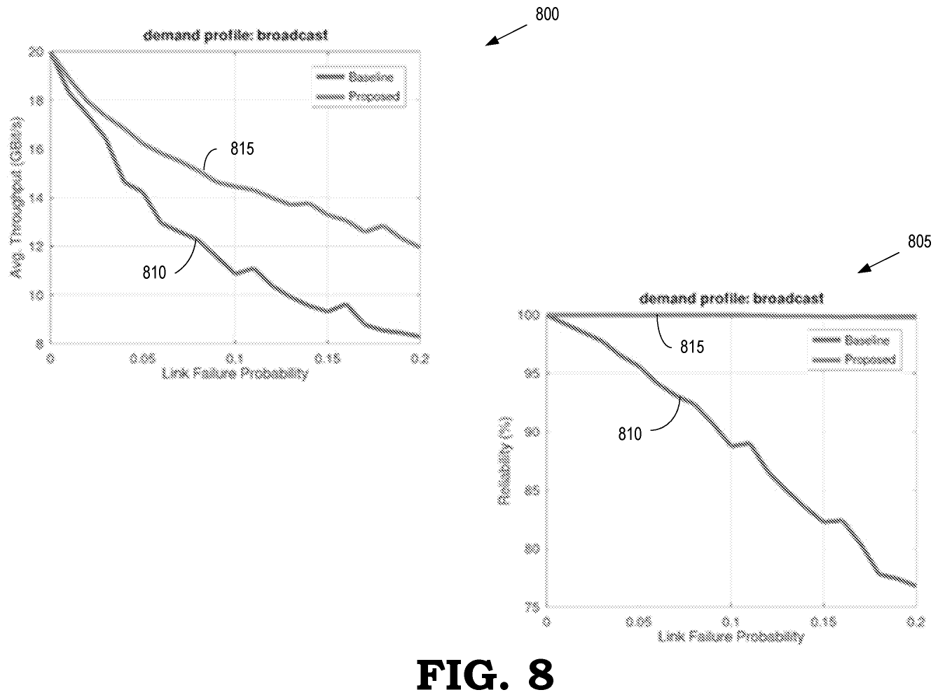

FIGS. 8-11 is result of averaging over 250 Monte-Carlo samples. Two methods are considered in the simulation study:
Baseline method: A conventional method (such as illustrated in FIGS. 3 and 4) where communication is simply done by routing packets (or dropping otherwise). As mentioned earlier, whenever there is a transmission opportunity at a node, its packets in a flow are divided into two parts and sent separately in both outgoing directions. A flow is completed when all packets are delivered to intended nodes. Note that sending all packets of the flow in a single direction would depend on network and demand conditions, thus introducing additional scheduling complexity (and non-deterministic performance issues). Therefore, such an approach of dividing the packets and sending separately in both outgoing directions is adopted, for benchmark purposes, without loss of generality.
Proposed method: The modified OPS node and communication protocol (such as illustrated in FIGS. 5-7) where algebraic combinations of packets are considered during communication. As mentioned earlier, packets of flows are combined and transmitted in all directions, without need of complicated control channel and scheduling policy.

The performance of above methods are evaluated under the following demand profiles:
Broadcast demand: Every node intends to deliver its packets to all other nodes in the network, in a given round.
P2P demand: In each round, a source node picks a destination node uniformly at random and keep sending packets until the round is complete.
Multicast demand: On top of P2P demand, one node uniformly selected in the network is permitted to transmit to N/2 destination nodes in total, where these destination nodes are also selected uniformly at random.
Server-client demand: On top of P2P demand in the network, one node uniformly picked at random is allowed to receive N/2 packets from the network in total, which are also selected uniformly at random. Observe that multicast and server-client demands are topologically identical due to ring network structure.

For a given method and demand profile in the beginning of each communication round, the nodes in the network start to operate in time, until their intended packet flows from both directions are delivered to the destinations, thus finalizing the communication round by employed method. Each incoming link or outgoing link is assumed to have 10 Gbit/s of capacity and each hop introduces one microsecond of delay due to propagation/transmission/processing. The following performance metrics are then calculated for each methods that have finished its round in certain amount of time steps:
Average Throughput: The average number of distinct packets delivered to destination in any node in unit time step. In a fully loaded broadcast demand situation with no link failures, the maximum throughput a node can achieve is 20 GBbit/s since each node has two incoming links with 10 Gbit/s of capacity.
Reliability: Total number of successfully received/decoded distinct packets is divided by total number of received/decoded+missing packets. This metric therefore quantifies a sort of reliability measure in which 100% of reliability is achieved when all intended packets are successfully decoded.

The evolution of these performance metrics with respect to the link failure probability, under all aforementioned demand profiles, is carried out in the following subsections.

FIG. 8 illustrates evolution of average throughput 800 and reliability 805 with respect to the link failure probability in a ring network of four nodes with a broadcast demand profile according to some embodiments. As seen from the figure, the proposed method 815 outperforms the baseline method 810 in terms of average throughput, and reliability. For example, for 10% of link failure events, the proposed method 805 has approximately 20% more throughput, 40 microsecond less delay, and 10% more reliability. The dramatic performance degradation (as link failures increase) for the baseline method 810 is because the baseline method 810 is unable to recover packets (despite re-submitting), whereas the proposed method 815 is more agile to this loss since it exploits algebraic combination of current/past packets in receive memory and directionality of encoded transmissions. Almost linear performance reliability allows the network to be more deterministic.

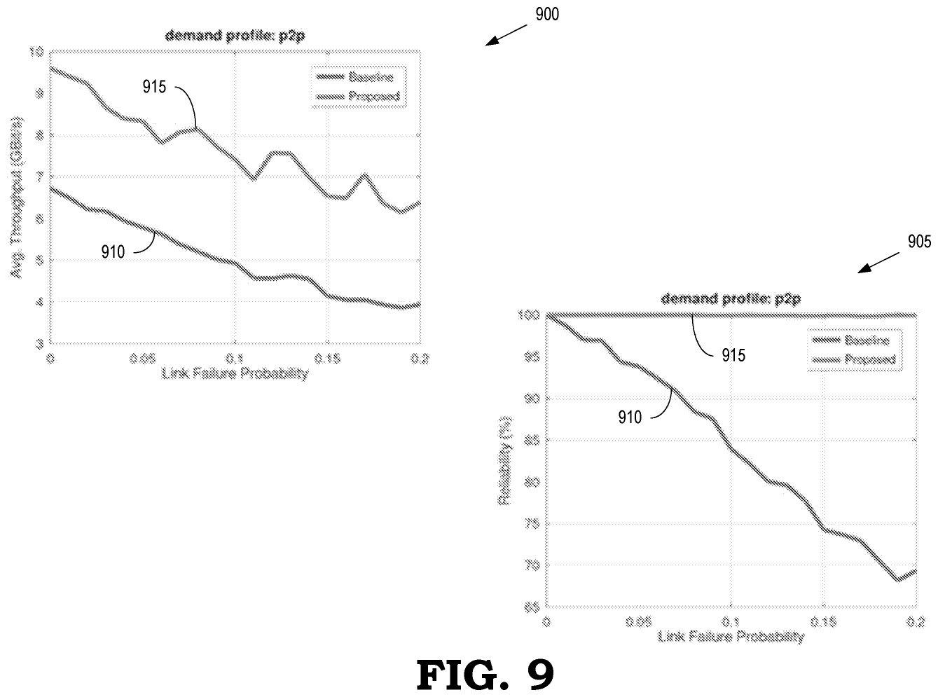

FIG. 9 illustrates evolution of average throughput 900 and reliability 905 with respect to the link failure probability in a ring network of four nodes with a peer-to-peer demand profile according to some embodiments. The proposed method 915 outperforms the baseline method 910 in all performance metrics. The average throughput with zero link failure is also better with the proposed method 915, since most communication is performed in fewer hops where the proposed method 915 exploits both directions with its communication scheme. In other words, the proposed method 915 has advantage over the baseline method 910, as it implicitly exploits the underlying symmetric nature of ring network and mathematical properties of transmission.

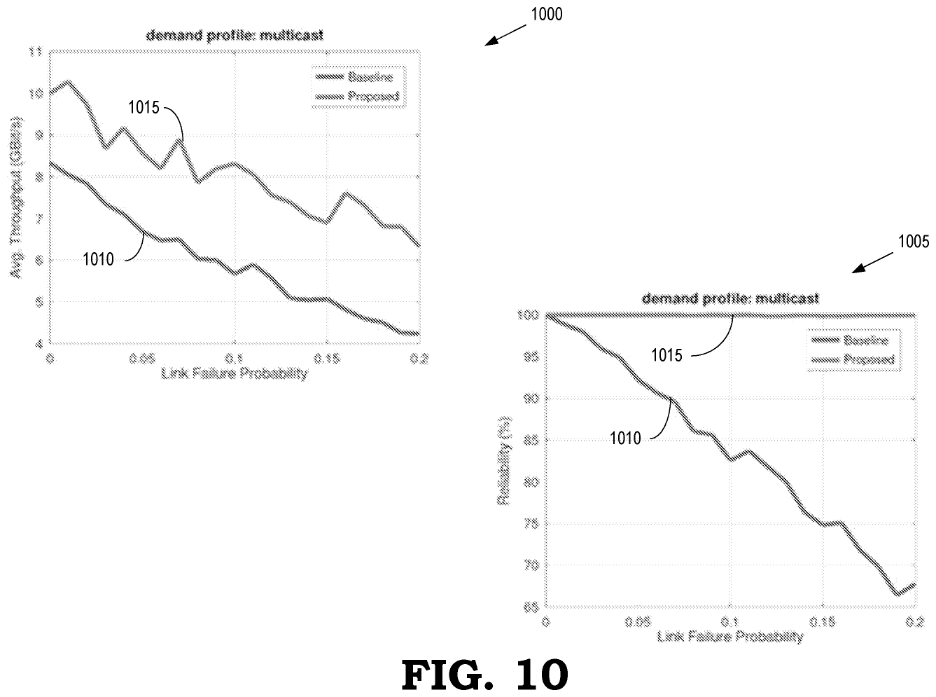

FIG. 10 illustrates evolution of average throughput 1000 and reliability 1005 with respect to the link failure probability in a ring network of four nodes with a multicast demand profile according to some embodiments. The details of performance gains show that the proposed method 1015 achieves superior performance to the baseline method 1010, at the cost of additional computational complexity.

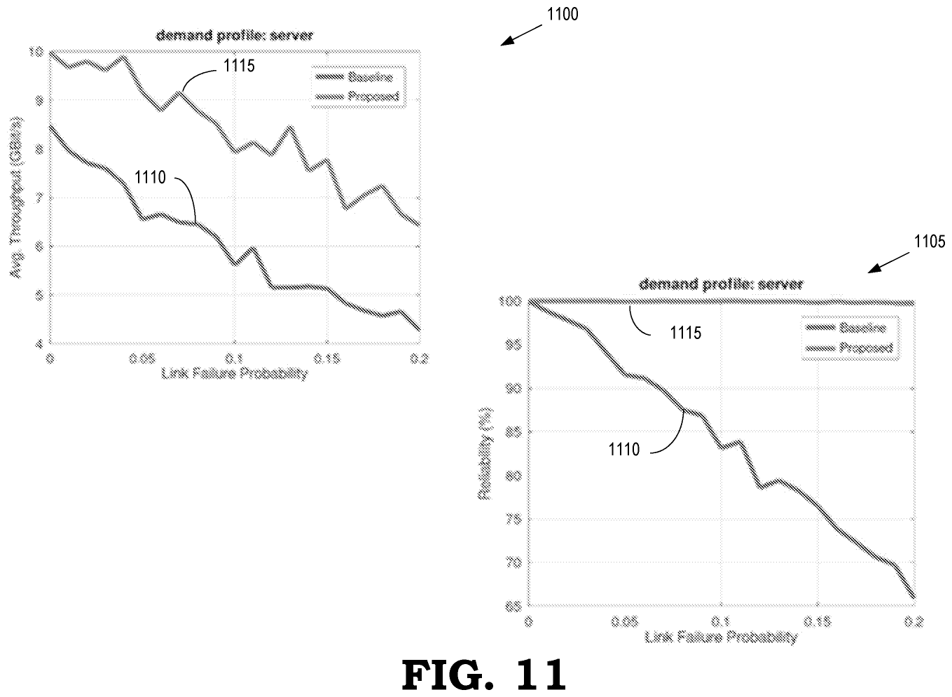

FIG. 11 illustrates evolution of average throughput 1100 and reliability 1105 with respect to the link failure probability in a ring network of four nodes with a server/client demand profile according to some embodiments. The server-client model is similar to the multicast demand profile, in the sense that the underlying demand topology has similar graph structure. Therefore, as expected, the performance of methods in multicast and server-client model are approximately identical, where the proposed method 1115 outperforms the baseline method 1110.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

As used herein, the term “circuitry” may refer to one or more or all of the following:
a) hardware-only circuit implementations (such as implementations and only analog and/or digital circuitry) and
b) combinations of hardware circuits and software, such as (as applicable):
   i. a combination of analog and/or digital hardware circuit(s) with software/firmware and
   ii. any portions of a hardware processor(s) with software (including digital signal processor(s), software, and memory(ies) that work together to cause an apparatus, such as a mobile phone or server, to perform various functions) and
c) hardware circuit(s) and/or processor(s), such as a microprocessor(s) or a portion of a microprocessor(s), that requires software (e.g., firmware) for operation, but the software may not be present when it is not needed for operation.
This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A first optical node configured for deployment in an optical network including at least one second optical node having a ring topology, the optical node comprising:
an optical encoder to form at least one third optical signal by combining a first optical signal with at least one second optical signal received by the first optical node from the at least one second optical node during a plurality of time intervals in a round.
wherein the first optical signal comprises a first optical packet that is partitioned into a first portion and a second portion,
wherein the at least one second optical signal comprises at least one second optical packet, and
wherein the optical encoder selectively combines the first portion of the first optical packet, the second portion of the first optical packet, and the at least one second optical packet based on the plurality of time intervals; and
a decoder to extract information from fourth optical signals received from the at least one second optical node.

2. The first optical node of claim 1, further comprising:
a receive buffer configured to store information representative of the fourth optical signals received from the at least one second optical node; and
a transmit buffer configured to store information used to generate the first optical signal.

3. The first optical node of claim 2, further comprising:
at least one optical arithmetic unit (OAU) configured to perform a binary exclusive-OR (XOR) on the information represented by the first optical signal and the at least one second optical signal to generate the at least one third optical signal.

4. The first optical node of claim 3, wherein the at least one third optical signal is transmitted during corresponding ones of the plurality of time intervals.

5. The first optical node of claim 4. wherein the at least one second optical packet is received from one of the at least one second optical node in a first direction relative to the first optical node in the ring topology and one of the at least one second optical node in a second direction relative to the first optical node in the ring topology

6. (canceled)

7. The first optical node of claim 3, wherein the optical encoder combines the first portion and the second portion of the first optical packet using an XOR operation during an initial time interval of the plurality of time intervals in the round thereby forming the at least one third optical signal for transmission in the first direction and the second direction.

8. The first optical node of claim 3, wherein, during an even time interval of the plurality of time intervals, the optical encoder forms the at least one third optical signal by combining the first portion with one of the at least one second optical packet received from the second direction to form a first portion of the at least one third optical signal for transmission in the first direction, and wherein the optical encoder forms the at least one third optical signal by combining the second portion with one of the at least one second optical packet received from the first direction to form a second portion of the at least one third optical signal for transmission in the second direction

9. The first optical node of claim 3, wherein, during an odd time interval of the plurality of time intervals, the optical encoder forms the at least one third optical signal by combining the first portion with one of the at least one second optical packet received from the first direction to form a first portion of the at least one third optical signal for transmission in the first direction, and wherein the optical encoder forms the at least one third optical signal by combining the second portion with one of the at least one second optical packet received from the second direction to form a second portion of the at least one third optical signal for transmission in the second direction

10. The first optical node of claim 3, wherein information representative of a plurality of fourth optical signals received from the at least one second optical node in the first direction and the second direction are stored in entries of the receive buffer during corresponding ones of the plurality of time intervals, and wherein the entries of the receive buffer store information representing linear combinations of optical signals generated by the at least one second optical node.

11. The first optical node of claim 10, wherein the decoder extracts information transmitted by the at least one second optical node from the information representing the linear combinations of the optical signals generated by the at least one second optical node.

12. The first optical node of claim 10, wherein the decoder performs error recovery using the information representing the linear combinations of the optical signals that were successfully received by the first optical node in response to a link failure.

13. A method for implementation in a first optical node configured for deployment in an optical network including at least one second optical node having a ring topology, the method comprising:
generating, in the first optical node, a first optical signal comprising a first optical packet;
partitioning the first optical packet into a first portion and a second portion, receiving, at the first optical node and from the at least one
second optical node, at least one second optical signal during a plurality of time intervals in a round, wherein the at least one second optical signal comprises at least one second optical packet;
selectively combining, at the first optical node, the first portion of the first optical packet, the second portion of the first optical packet, and the at least one second optical packet based on the plurality of time intervals to form at least one third optical signal; and
transmitting the at least one third optical signal into the optical network.

14. The method of claim 13, further comprising:
storing, in a transmit buffer, information used to generate the first optical signal

15. The method of claim 14, wherein combining the first optical signal and the at least one second optical signal comprises performing, using at least one optical arithmetic unit (OAU), a binary exclusive-OR (XOR) on the information represented by the first optical signal and the second optical signal to generate the at least one third optical signal.

16. The method of claim 15, wherein transmitting the at least one third optical signal comprises transmitting plurality of third optical signals during corresponding ones of the plurality of time intervals.

17. The method of claim 16, wherein a plurality of second optical packets are received from one of the at least one second optical node in a first direction relative to the first optical node in the ring topology and one of the at least one second optical node in a second direction relative to the first optical node in the ring topology.

18. (canceled)

19. The method of claim13, wherein selectively combining further comprises combining the first portion and the second portion of the first optical packet using an XOR operation during an initial time interval of the plurality of time intervals in the round, and wherein transmitting the third signal comprises transmitting the combined first and second portions of the first optical packet in the first direction and the second direction.

20. The method of claim 13, wherein selectively combining further comprises combining, during an even time interval of the plurality of time intervals, the first portion with one of the at least on second optical packet received from the second direction and combining the second portion with one of the at least one second optical packet received from the first direction, and wherein transmitting the at least one third optical signal comprises transmitting the combined first portion and one of the second optical packets in the first direction transmitting the combined second portion and the other one of the second optical packets in the second direction.

21. The method of claim 13, wherein selectively combining further comprises combining, during an odd time interval of the plurality of time intervals, the first portion with one of the at least one second optical packet received from the first direction and combining the second portion with one of the at least one second optical packet received from the second direction, and wherein transmitting the at east one third optical signal comprises transmitting the combined first portion and one of the second optical packets in the first direction transmitting the combined second portion and the other one of the second optical packets in the second direction.

22. A method for implementation in a first optical node configured for deployment in an optical network including second optical nodes having a ring topology, the method comprising:
receiving, at the first optical node and from at least one of the second optical nodes, an optical signal comprising information representing linear combinations of optical signals previously received by the second optical nodes;
extracting, at the first optical node and from the optical signal, information conveyed in the optical signals previously received by the second optical nodes, and
in response to a link failure in the optical network, performing error recovery using information presenting the linear combinations of the optical signals that were successfully received prior to the link failure.

23. The method of claim 22, wherein the information representing the linear combinations of the optical signals comprises information generated by performing a binary exclusive-OR (XOR) on optical signals received and generated by the second optical nodes.

24. The method of claim 23, further comprising:
storing, in a receive buffer, information representative of the optical signal received from the second optical nodes.

25. The method of claim 24, wherein receiving the optical signal from the second optical nodes comprises receiving a plurality of optical signals during a plurality of time intervals in a round, and wherein storing the information representative of the optical signal comprises storing the information representative of the plurality of optical signals in a plurality of entries of the receive buffer that correspond to the plurality of time intervals.

26. The method of claim 25, wherein extracting information conveyed in the optical signals comprises extracting the information using matrix operations determined by the ring topology.

27. (canceled)
